(19) United States
(12) Patent Application Publication
(10) Pub. No.: US 2026/0196831 A1
(43) Pub. Date: Jul. 9, 2026

(54) REACTIVE POWER CONTROL METHOD FOR SUPPRESSING TRANSIENT OVERVOLTAGE IN DC SENDING-END POWER GRID OF NEW ENERGY

(71) Applicant: SOUTHWEST JIAOTONG UNIVERSITY, Chengdu (CN)

(72) Inventors: Bo PANG, Chengdu (CN); Xiaojuan ZHU, Chengdu (CN); Yi TANG, Chengdu (CN); Quanwang ZHANG, Chengdu (CN); Kai LIAO, Chengdu (CN); Jianwei YANG, Chengdu (CN); Zhengyou HE, Chengdu (CN)

(21) Appl. No.: 19/559,664

(22) Filed: Mar. 6, 2026

Related U.S. Application Data
(63) Continuation-in-part of application No. PCT/CN2025/144171, filed on Dec. 22, 2025.

(30) Foreign Application Priority Data
Dec. 30, 2024 (CN) 202411961929.0

(51) Int. Cl. H02J 3/001; H02J 3/36; H02J 3/38; H02J 3/50; H02J 101/24; H02J 101/28; H02J 103/35

(52) U.S. Cl. CPC H02J 3/00125; H02J 3/36; H02J 3/381; H02J 3/50; H02J 2101/24; H02J 2101/28; H02J 2103/35

(57) ABSTRACT

Disclosed is a reactive power control method for suppressing a transient overvoltage in a DC sending-end power grid of new energy. The method estimates the trend of grid voltage changes by using current and historical signals of the grid voltage, calculates the reactive power command offset value to achieve the effect of reactive power lead control, and combines the optimized reactive power value after lag compensation. The superposition of the lag compensation and the reactive power optimization generates a final command value for a new energy power source, and this command value can ensure that new energy effectively outputs reactive power to participate in the suppression of the transient overvoltage in a DC converter station.

### CROSS-REFERENCE TO RELATED APPLICATIONS

This application is a continuation of International Application No. PCT/CN2025/144171, filed on Dec. 22, 2025, which claims priority to Chinese Patent Application No. 202411961929.0, filed on Dec. 30, 2024. The disclosures of the aforementioned applications are hereby incorporated by reference in their entireties.

### TECHNICAL FIELD

The present disclosure belongs to the technical field of new energy operation control, and particularly relates to a reactive power control method for suppressing a transient overvoltage in a DC sending-end power grid of new energy.

### BACKGROUND

New energy resources are usually located in remote areas such as deserts, high mountains, and open seas, far away from electricity load centers. The resulting reverse source-load distribution characteristics make long-distance HVDC transmission an important method for new energy power transmission. However, for a large number of conventional DC transmission systems constructed previously, namely line-commutated converter high-voltage direct current (LCC-HVDC) systems, the semi-controlled characteristics of thyristors thereof lead to inevitable DC commutation failure in LCC-HVDC, which in turn causes a transient overvoltage in an AC sending-end power grid. This transient overvoltage phenomenon will increase the risk of overvoltage tripping of new energy power sources and may further trigger cascading faults. Therefore, suppressing the transient overvoltage of the LCC-HVDC sending-end power grid has become one of the key requirements for ensuring the stable operation of new energy DC delivery systems.

Current measures to suppress the transient overvoltage in the LCC-HVDC sending-end power grid are mainly divided into two categories. One category is to add a reactive power compensation device in the sending-end power grid. For example, the paper A Flexible Control Strategy to Prevent Sending-end Power System From Transient Instability Under HVDC Repetitive Commutation Failures published in IEEE Transactions on Power Systems, Volume 35, Issue 6, 2020, proposes an energy storage link design and control method for the transient overvoltage, which suppresses the transient overvoltage through active voltage control of an energy storage link. The paper Comparative Study on Transient Overvoltage Suppression Capabilities of Grid-Forming Energy Storage and Synchronous Condenser published in Zhejiang Electric Power, Issue 2, 2024, clarifies the effectiveness of additional grid-forming energy storage and additional synchronous condensers in suppressing the transient overvoltage. The other category is to adjust the DC control strategy of LCC-HVDC. For example, the paper Reactive Power Control Strategy for Inhibiting Transient Overvoltage Caused by Commutation Failure published in IEEE Transactions on Power Systems, Volume 36, Issue 5, 2021, proposes an HVDC constant reactive power control strategy, which can control the DC voltage and current of the DC transmission system during faults to increase the reactive power consumption of a rectifier during faults, thereby reducing the transient overvoltage of the sending-end power grid. However, it should be clarified that the method for suppressing the transient overvoltage by adding the reactive power regulation device in the sending-end power grid will introduce additional construction and maintenance costs, and the long-term utilization rate of the reactive power device is low, resulting in poor overall economic efficiency. Adjusting the DC control of LCC-HVDC can reduce the transient overvoltage while affecting the dynamic performance of the DC control system, such as the fault ride-through capability and the DC current recovery capability.

### SUMMARY

An objective of the present disclosure is to provide a reactive power control method for suppressing a transient overvoltage in a DC sending-end power grid of new energy so as to overcome the defects in the prior art. The present disclosure estimates the trend of grid voltage changes by using current and historical signals of the grid voltage, generates the reactive lead control effect, and conducts lag compensation on power command signals to offset the reactive power lag generated in the processes of power command calculation, transmission, and the like, thereby ensuring that value can ensure that the leading reactive power is applied to overvoltage suppression. This algorithm, while implementing transient overvoltage suppression, requires no additional devices and exerts no additional impacts on a DC control system, thereby flexibly utilizing the power regulation capability of a new energy power source. Specific implementation steps are as follows:
S1, acquiring a real-time effective value U of a terminal voltage of a new energy power source by using a voltage detection link of the new energy power source or an output of a phase-locked loop, performing fixed-step sampling on the real-time effective value U according to a sampling period ΔT to obtain a real-time effective value Uₜ of the terminal voltage of the new energy power source at a current moment t, denoting real-time effective values of the terminal voltage of the new energy power source at previous sampling moments as Uₜ₋₁, Uₜ₋₂, . . . , Uₜ₋ₙ, respectively, and calculating equivalent grid voltage amplitudes Vₜ, Vₜ₋₁, . . . , Vₜ₋ₙ at different moments according to the terminal voltage of the new energy power source at various sampling moments;
S2, calculating first-order difference components V¹ of the grid voltage amplitude at different moments by using the equivalent grid voltage amplitudes Vₜ, Vₜ₋₁, . . . , Vₜ₋ₙ at different moments, denoting the first-order difference component of the equivalent grid voltage amplitude at the current moment as

$${V}_{t}^{1} ,$$

and denoting the first-order difference components of the voltage amplitude at previous moments as

$${V}_{t - 1}^{1} , {V}_{t - 2}^{1} , … , {V}_{t - n}^{1} ,$$

respectively;
S3, calculating second-order difference components V² of the grid voltage amplitude at different moments by using the first-order difference components of the voltage amplitude at different moments, denoting the second-order difference component of the equivalent grid voltage amplitude at the current moment as

$${V}_{t}^{2} ,$$

and denoting the second-order difference components of the voltage amplitude at the previous moments as

$${V}_{t - 1}^{2} , {V}_{t - 2}^{2} , … , {V}_{t - n}^{2} ,$$

respectively;
S4, calculating third-order difference components V³ of the grid voltage amplitude at different moments by using the second-order difference components of the voltage amplitude at different moments, denoting the third-order difference component of the equivalent grid voltage amplitude at the current moment as

$${V}_{t}^{3} ,$$

and denoting the third-order difference components of the voltage amplitude at the previous moments as

$${V}_{t - 1}^{3} , {V}_{t - 2}^{3} , … , {V}_{t - n}^{3} ,$$

respectively;
S5, calculating a reactive power command compensation component

$$Δ {Q}_{t}^{*}$$

of a new energy unit at the current moment t by using the first-order difference component, the second-order difference component, and the third-order difference component of the voltage amplitude at the current moment t, namely

$${V}_{t}^{1} , {V}_{t}^{2} , and {V}_{t}^{3} ,$$

and denoting the reactive power command compensation components at the previous moments as

$$Δ {Q}_{t - 1}^{*} , Δ {Q}_{t - 2}^{*} , Δ {Q}_{t - n}^{*} ,$$

respectively;
S6, calculating an optimized reactive power command value

$${Q}_{p \_ t}^{*}$$

at different moments by using basic reactive power command values (Qₜ, Qₜ₋₁, . . . , Qₜ₋ₙ) of the new energy unit at different moments, so as to realize lag compensation of a reactive power command; and
S7, adding the optimized reactive power command value

$${Q}_{p \_ t}^{*}$$

and the reactive power command compensation component

$$Δ {Q}_{t}^{*}$$

to obtain the reactive power command

$${Q}_{t}^{*}$$

of the new energy unit, sending the power command to a new energy converter, and completing power command tracking through the new energy converter.

Further, in the S1, the equivalent grid voltage amplitudes at different moments are obtained through the following equation (1) so as to play a role in smoothing filtering:

$$\{ \begin{matrix}{V}_{t} = \frac{{U}_{t} + {U}_{t - 1} + {U}_{t - 2} + {U}_{t - 3}}{4} \\ \begin{matrix}⋮ & ⋮\end{matrix} \\ {V}_{t - n} = \frac{{U}_{t - n} + {U}_{t - n - 1} + {U}_{t - n - 2} + {U}_{t - n - 3}}{4}\end{matrix} . \qquad ( 1 )$$

Further, in the S2, the first-order difference components of the voltage amplitude at different moments are obtained through the following equation (2):

$$\{ \begin{matrix}{V}_{t}^{1} = {V}_{t} - {V}_{t - 1} \\ \begin{matrix}⋮ & ⋮\end{matrix} \\ {V}_{t - n}^{2} = {V}_{t - n}^{1} - {V}_{t - n - 1}^{1}\end{matrix} . \qquad ( 2 )$$

Further, in the S3, the second-order difference components of the voltage amplitude at different moments are obtained through the following equation (3):

$$\{ \begin{matrix}{V}_{t}^{2} = {V}_{t}^{1} - {V}_{t - 1}^{1} \\ \begin{matrix}⋮ & ⋮\end{matrix} \\ {V}_{t - n}^{2} = {V}_{t - n}^{1} - {V}_{t - n - 1}^{1}\end{matrix} . \qquad ( 3 )$$

Further, in the S4, the third-order difference components of the voltage amplitude at different moments are obtained through the following equation (4):

$$\{ \begin{matrix}{V}_{t}^{3} = {V}_{t}^{3} - {V}_{t - 1}^{3} \\ \begin{matrix}⋮ & ⋮\end{matrix} \\ {V}_{t - n}^{3} = {V}_{t - n}^{3} - {V}_{t - n - 1}^{3}\end{matrix} . \qquad ( 4 )$$

Further, in the S5, the reactive power command compensation component at different moments is obtained through the following equation (5), in the equation, kᵥ represents a reactive power compensation coefficient, which is designed as 1.5 as recommended by grid connection guidelines, or also adjusted and increased according to actual reactive power output capacity of the new energy unit:

$$\{ \begin{matrix}Δ {Q}_{t}^{*} = {k}_{v} ( {V}_{t}^{1} + {V}_{t}^{2} + {V}_{t}^{3} ) {I}_{N} \\ \begin{matrix}⋮ & ⋮\end{matrix} \\ Δ {Q}_{t - n}^{*} = {k}_{v} ( {V}_{t - n}^{1} + {V}_{t - n}^{2} + {V}_{t - n}^{3} ) {I}_{N}\end{matrix} . \qquad ( 5 )$$

Further, in the S6, the optimized reactive power command value

$${Q}_{p \_ t}^{*}$$

at different moments t is obtained through lead-lag compensation calculation of the basic reactive power command values Qₜ at different moments, specifically through the equation (6), in the equation,

$${Q}_{p \_ 1}^{*} and {Q}_{p \_ 0}^{*}$$

respectively represent the optimized basic reactive power command values at an initial moment and a first moment of an algorithm, and Q₁ and Q₀ respectively represent the reactive power command values at the initial moment and the first moment of the algorithm:

$$\{ \begin{matrix}{Q}_{p \_ t}^{*} = {Q}_{p \_ t - 1}^{*} - 1.49 {Q}_{p \_ t - 1}^{*} + {Q}_{t} - 1.4 {Q}_{t - 1} + 0.52 {Q}_{t - 2} \\ \begin{matrix}⋮ & ⋮\end{matrix} \\ {Q}_{p \_ 1}^{*} = {Q}_{1} \\ {Q}_{p \_ 0}^{*} = {Q}_{0}\end{matrix} . \qquad ( 6 )$$

Further, in the S7, the reactive power command

$${Q}_{t}^{*}$$

of the new energy unit at different moments t is obtained by adding the optimized reactive power command value

$${Q}_{p \_ t}^{*}$$

and the reactive power command compensation component

$$Δ {Q}_{t}^{*} ,$$

and the calculation process is completed through the following equation (7):

$${Q}_{t}^{*} = {Q}_{p \_ t}^{*} + Δ {Q}_{t}^{*} . \qquad ( 7 )$$

Compared with the prior art, the present disclosure adopts the aforementioned technical solutions and achieves the following technical effects:

(1) Compared with existing methods for suppressing a transient overvoltage in a DC sending-end power grid, the reactive power control method for suppressing a transient overvoltage in a DC sending-end power grid of new energy provided by the present disclosure has the advantages of high economic efficiency and low control costs. The existing methods for suppressing a transient overvoltage in a DC sending-end power grid either require introduction of additional reactive power devices, which increases construction and operation costs, or sacrifice the dynamic control performance of the DC system. In contrast, the reactive power control method developed by the present disclosure does not rely on additional devices, exerts no negative impacts on the DC control system, and thus has the advantage of low control costs.

(2) The reactive power control method provided by the present disclosure only performs power command optimization, and does not require adjustments to the original system structure, control mode, or parameters of converters in the new energy converter control system, which also does not require the acquisition of new energy unit parameters. This method can be directly applied to existing operating units without changing the original power tracking control logic of new energy, and thus has good engineering practicality.

(3) The reactive power control method provided by the present disclosure imposes no special requirements on the type, control mode, or signal acquisition method of the new energy generating units, including no specific restrictions on voltage signal acquisition, power tracking control modes, reactive power command sending methods, and the like. This algorithm is applicable to a wide range of power sources or energy storage systems based on power electronic devices, such as photovoltaic, wind power, and energy storage systems with different control modes, and thus has strong engineering scenario adaptability.

### BRIEF DESCRIPTION OF THE DRAWINGS

FIG. 1 is an operation topology diagram of a new energy power source connected via LCC-HVDC transmission.

FIG. 2 shows a logical relationship between an algorithm of the present disclosure and an original new energy control system.

FIG. 3 shows a flow chart of a reactive power command generation algorithm for a reactive power control method for new energy of the present disclosure.

FIG. 4 shows a transient voltage waveform at a new energy terminal in the case of a new energy generation power of 2,500 MW, including a comparison between scenarios with and without addition of an algorithm of the present disclosure.

### DETAILED DESCRIPTIONS OF THE EMBODIMENTS

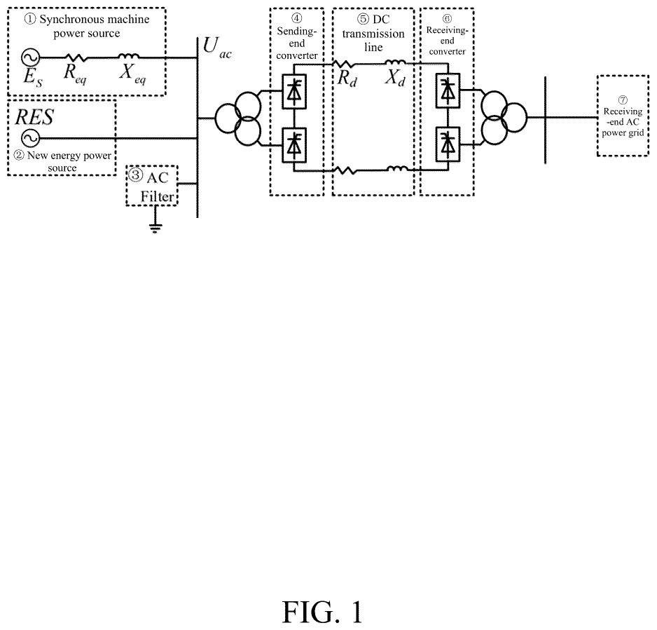

The technical solutions in the embodiments of the present disclosure will be clearly and completely described below with reference to the accompanying drawings. Obviously, the described embodiments are merely some embodiments rather than all embodiments of the present disclosure. All the other embodiments obtained by those of ordinary skill in the art based on the embodiments in the present disclosure without creative efforts shall fall within the protection scope of the present disclosure. A reactive power control method for suppressing a transient overvoltage in a DC sending-end power grid of new energy is shown in FIG. 1. The total power source capacity of the sending-end power grid is 5,000 MW, of which a new energy power source accounts for 2,500 MW. A rated DC voltage is ±800 kV, a rated AC voltage is 525 kV, and DC transmission adopts a line-commutated converter high-voltage direct current (LCC-HVDC) structure. In FIG. 1, (1) represents a synchronous machine power source with a rated voltage of 530 kV, (2) represents a new energy power source, represented by a wind power plant in this embodiment, obtained by equivalent aggregation of power from multiple wind turbines; (3) represents a passive AC filter, configured to meet reactive power consumption of a sending-end converter during normal operation, with a capacity of 1,500 MVar, where U_{ac} represents an AC bus of the sending-end converter; (4) represents an LCC-HVDC sending-end converter, which, together with (5) representing a DC transmission line and (6) representing a receiving-end converter, constitutes an LCC-HVDC transmission system; and (7) represents a receiving-end AC power grid.

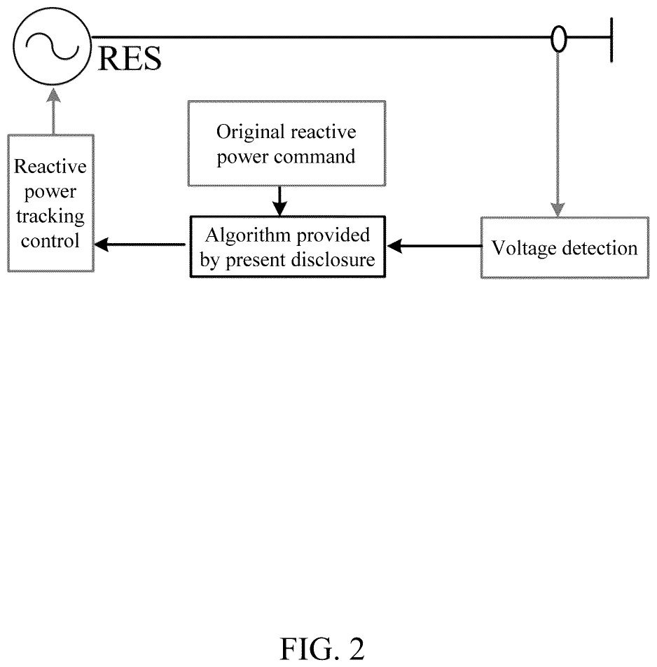

FIG. 2 shows a logical relationship between an algorithm of the present disclosure and an original new energy control system. The algorithm provided by the present disclosure utilizes voltage detection signals inherent in a new energy unit to obtain the grid voltage, corrects the original reactive power command of the new energy unit based on the grid voltage, and calculates the optimized reactive power command. The specific tracking process of the reactive power command is implemented by the converter inherent in the unit.

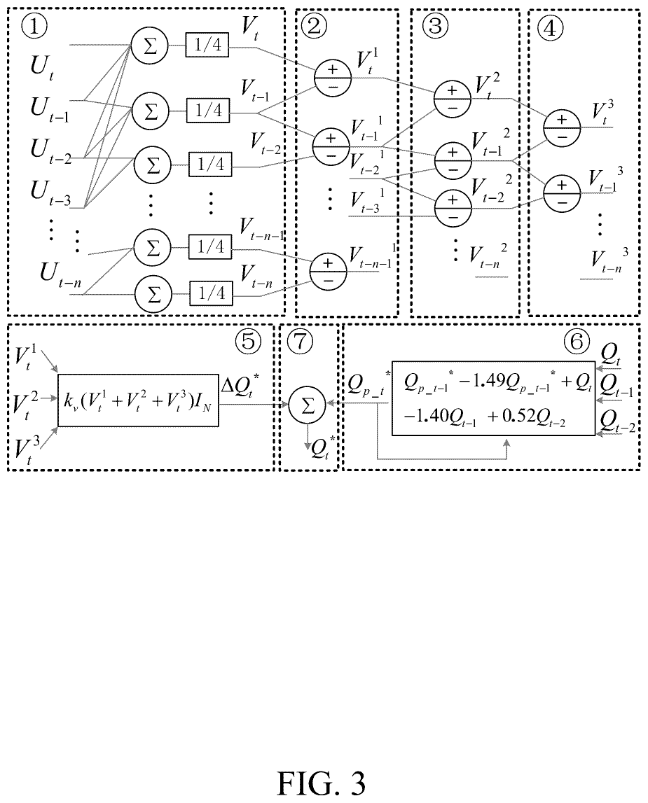

FIG. 3 presents a specific implementation of the algorithm of the present disclosure, where (1) represents a smoothing filtering process of the voltage detection signals, (2) represents a first-order difference component calculation process of a voltage amplitude, (3) represents a second-order difference component calculation process of the voltage amplitude, (4) represents a third-order difference component calculation process of the voltage amplitude, (5) represents a reactive power command compensation component calculation process, (6) represents optimized reactive power command value calculation, and (7) represents reactive power command calculation for the new energy unit.

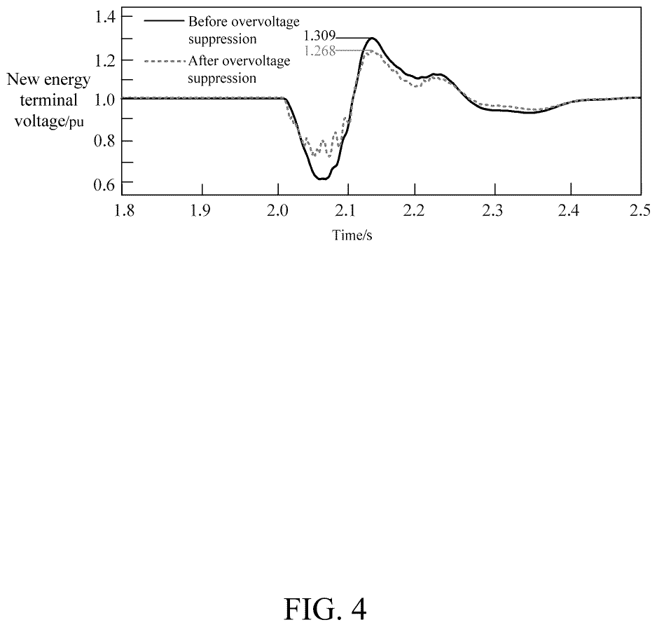

FIG. 4 shows a transient voltage waveform at a new energy terminal in the case of A new energy generation power of 2,500 MW, that is, new energy accounts for 50% of the sending-end power grid, and a short-circuit ratio of the power grid is 2.5. In FIG. 4, the solid line represents a transient voltage curve at the new energy terminal without addition of a transient overvoltage suppression algorithm, where a transient overvoltage amplitude is 1.309 pu, the dashed line represents a transient voltage curve at the new energy terminal with addition of the algorithm provided by the present disclosure, where a transient overvoltage amplitude is 1.268 pu. This indicates that the algorithm provided by the present disclosure is effective and feasible for transient overvoltage suppression.

The specific implementation includes the following steps:

S1, a real-time effective value U of a terminal voltage of a new energy power source is acquired by using a voltage detection link of the new energy power source or an output of a phase-locked loop, and fixed-step sampling is performed on the real-time effective value U according to a sampling period ΔT to obtain a real-time effective value Uₜ of the terminal voltage of the new energy power source at a current moment t. Real-time effective values of the terminal voltage of the new energy power source at previous sampling moments are denoted as Uₜ₋₁, Uₜ₋₂, . . . , Uₜ₋ₙ, respectively, and equivalent grid voltage amplitudes Vₜ, Vₜ₋₁, . . . , Vₜ₋ₙ at different moments are calculated according to the terminal voltage of the new energy power source at various sampling moments.

S2, first-order difference components V¹ of the grid voltage amplitude at different moments are calculated by using the equivalent grid voltage amplitudes Vₜ, Vₜ₋₁, . . . , Vₜ₋ₙ at different moments, the first-order difference component of the equivalent grid voltage amplitude at the current moment is denoted as

$${V}_{t}^{1} ,$$

and the first-order difference components of the voltage amplitude at previous moments are denoted as

$${V}_{t - 1}^{1} , {V}_{t - 2}^{1} , … , {V}_{t - n}^{1} ,$$

respectively.

S3, second-order difference components V² of the grid voltage amplitude at different moments are calculated by using the first-order difference components of the voltage amplitude at different moments, the second-order difference component of the equivalent grid voltage amplitude at the current moment is denoted as

$${V}_{t}^{2} ,$$

and the second-order difference components of the voltage amplitude at the previous moments are denoted as

$${V}_{t - 1}^{2} , {V}_{t - 2}^{2} , … , {V}_{t - n}^{2} ,$$

respectively.

S4, third-order difference components V³ of the grid voltage amplitude at different moments are calculated by using the second-order difference components of the voltage amplitude at different moments, the third-order difference component of the equivalent grid voltage amplitude at the current moment is denoted as

$${V}_{t}^{3} ,$$

and the third-order difference components of the voltage amplitude at the previous moments are denoted as

$${V}_{t - 1}^{3} , {V}_{t - 2}^{3} , … , {V}_{t - n}^{3} ,$$

respectively.

S5, a reactive power command compensation component

$$Δ {Q}_{t}^{*}$$

or a new energy unit at the current moment t is calculated by using the first-order difference component, the second-order difference component, and the third-order difference component of the voltage amplitude at the current moment t, namely

$${V}_{t}^{1} , {V}_{t}^{2} , and {V}_{t}^{3} ,$$

and the reactive power command compensation components at the previous moments are denoted as

$$Δ {Q}_{t - 1}^{*} , Δ {Q}_{t - 2}^{*} , … , Δ {Q}_{t - n}^{*} ,$$

respectively.

S6, an optimized reactive power command value

$${Q}_{p \_ t}^{*}$$

at different moments is calculated by using basic reactive power command values (Qₜ, Qₜ₋₁, . . . , Qₜ₋ₙ) of the new energy unit at different moments, so as to realize lag compensation of a reactive power command.

S7, the optimized reactive power command value

$${Q}_{p \_ t}^{*}$$

and the reactive power command compensation component

$$Δ {Q}_{t}^{*}$$

are added to obtain the reactive power command

$${Q}_{t}^{*}$$

of the new energy unit, the power command is sent to a new energy converter, and power command tracking is completed through the new energy converter.

Further, in the S1, the equivalent grid voltage amplitudes at different moments are obtained through the following equation (1) so as to play a role in smoothing filtering:

$$\{ \begin{matrix}{V}_{t} = \frac{{U}_{t} + {U}_{t - 1} + {U}_{t - 2} + {U}_{t - 3}}{4} \\ \begin{matrix}⋮ & ⋮\end{matrix} \\ {V}_{t - n} = \frac{{U}_{t - n} + {U}_{t - n - 1} + {U}_{t - n - 2} + {U}_{t - n - 3}}{4}\end{matrix} . \qquad ( 1 )$$

Further, in the S2, the first-order difference components of the voltage amplitude at different moments are obtained through the following equation (2):

$$\{ \begin{matrix}{V}_{t}^{1} = {V}_{t} - {V}_{t - 1} \\ \begin{matrix}⋮ & ⋮\end{matrix} \\ {V}_{t - n}^{1} = {V}_{t - n} - {V}_{t - n - 1}\end{matrix} . \qquad ( 2 )$$

Further, in the S3, the second-order difference components of the voltage amplitude at different moments are obtained through the following equation (3):

$$\{ \begin{matrix}{V}_{t}^{2} = {V}_{t}^{1} - {V}_{t - 1}^{1} \\ \begin{matrix}⋮ & ⋮\end{matrix} \\ {V}_{t - n}^{2} = {V}_{t - n}^{1} - {V}_{t - n - 1}^{1}\end{matrix} . \qquad ( 3 )$$

Further, in the S4, the third-order difference components of the voltage amplitude at different moments are obtained through the following equation (4):

$$\{ \begin{matrix}{V}_{t}^{3} = {V}_{t}^{3} - {V}_{t - 1}^{3} \\ \begin{matrix}⋮ & ⋮\end{matrix} \\ {V}_{t - n}^{3} = {V}_{t - n}^{3} - {V}_{t - n - 1}^{3}\end{matrix} . \qquad ( 4 )$$

Further, in the S5, the reactive power command compensation component at different moments is obtained through the following equation (5), in the equation, kᵥ represents a reactive power compensation coefficient, which is designed as 1.5 as recommended by grid connection guidelines, or also adjusted and increased according to actual reactive power output capacity of the new energy unit:

$$\{ \begin{matrix}Δ {Q}_{t}^{*} = {k}_{v} ( {V}_{t}^{1} + {V}_{t}^{2} + {V}_{t}^{3} ) {I}_{N} \\ \begin{matrix}⋮ & ⋮\end{matrix} \\ Δ {Q}_{t - n}^{*} = {k}_{v} ( {V}_{t - n}^{1} + {V}_{t - n}^{2} + {V}_{t - n}^{3} ) {I}_{N}\end{matrix} . \qquad ( 5 )$$

Further, in the S6, the optimized reactive power command value

$${Q}_{p \_ t}^{*}$$

at different moments t is obtained through lead-lag compensation calculation of the basic reactive power command values Qₜ at different moments, specifically through the equation (6), in the equation,

$${Q}_{p \_ 1}^{*} and {Q}_{p \_ 0}^{*}$$

respectively represent the optimized basic reactive power command values at an initial moment and a first moment of an algorithm, and Q₁ and Q₀ respectively represent the reactive power command values at the initial moment and the first moment of the algorithm:

$$\{ \begin{matrix}{Q}_{p \_ t}^{*} = {Q}_{p \_ t - 1}^{*} - 1.49 {Q}_{p \_ t - 1}^{*} + {Q}_{t} - 1.4 {Q}_{t - 1} + 0.52 {Q}_{t - 2} \\ \begin{matrix}⋮ & ⋮\end{matrix} \\ {Q}_{p \_ 1}^{*} = {Q}_{1} \\ {Q}_{p \_ 0}^{*} = {Q}_{0}\end{matrix} . \qquad ( 6 )$$

Further, in the S7, the reactive power command

$${Q}_{t}^{*}$$

of the new energy unit at different moments t is obtained by adding the optimized reactive power command value

$${Q}_{p \_ t}^{*}$$

and the reactive power command compensation component

$$Δ {Q}_{t}^{*} ,$$

and the calculation process is completed through the following equation (7):

$${Q}_{t}^{*} = {Q}_{p \_ t}^{*} + Δ {Q}_{t}^{*} . \qquad ( 7 )$$

The above description of the embodiments is intended to facilitate the understanding and application of the present disclosure by personnel in the relevant technical field. Those who possess the basic knowledge in this technical field can obviously easily make various modifications to the above embodiments and apply the general principles set forth herein to other embodiments without any creative effort. Therefore, the present disclosure is not limited to the above embodiments. Any improvements and modifications that are irrelevant to the core concept and are made to the present disclosure by those skilled in the art based on the algorithmic ideas consistent with the concept of the present disclosure should fall within the protection scope of the present disclosure, which includes but is not limited to the following cases: the signal detection in the S1 adopts other methods other than the voltage amplitude or phase-locked loop detection described in this embodiment, the signal filtering link in the S1 is replaced with other methods instead of average value filtering, different signal lag compensation algorithms are adopted in the S6, and the other cases.

What is claimed is:

1. A reactive power control method for suppressing a transient overvoltage in a DC sending-end power grid of new energy, comprising the following steps:
S1, acquiring a real-time effective value U of a terminal voltage of a new energy power source by using a voltage detection link of the new energy power source or an output of a phase-locked loop, performing fixed-step sampling on the real-time effective value U according to a sampling period ΔT to obtain a real-time effective value Uₜ of the terminal voltage of the new energy power source at a current moment t, denoting real-time effective values of the terminal voltage of the new energy power source at previous sampling moments as Uₜ₋₁, Uₜ₋₂, . . . , Uₜ₋ₙ, respectively, and calculating equivalent grid voltage amplitudes Vₜ, Vₜ₋₁, . . . , Vₜ₋ₙ at different moments according to the terminal voltage of the new energy power source at various sampling moments;
S2, calculating first-order difference components V¹ of the grid voltage amplitude at different moments by using the equivalent grid voltage amplitudes Vₜ, Vₜ₋₁, . . . , Vₜ₋ₙ at different moments, denoting the first-order difference component of the equivalent grid voltage amplitude at the current moment as
$${V}_{t}^{1} ,$$
and denoting the first-order difference components of the voltage amplitude at previous moments as
$${V}_{t - 1}^{1} , {V}_{t - 2}^{1} , … , {V}_{t - n}^{1} ,$$
respectively;
S3, calculating second-order difference components V² of the grid voltage amplitude at different moments by using the first-order difference components of the voltage amplitude at different moments, denoting the second-order difference component of the equivalent grid voltage amplitude at the current moment as
$${V}_{t}^{2} ,$$
and denoting the second-order difference components of the voltage amplitude at the previous moments as
$${V}_{t - 1}^{2} , {V}_{t - 2}^{2} , … , {V}_{t - n}^{2} ,$$
respectively;
S4, calculating third-order difference components V³ of the grid voltage amplitude at different moments by using the second-order difference components of the voltage amplitude at different moments, denoting the third-order difference component of the equivalent grid voltage amplitude at the current moment as
$${V}_{t}^{3} ,$$
and denoting the third-order difference components of the voltage amplitude at the previous moments as
$${V}_{t - 1}^{3} , {V}_{t - 2}^{3} , … , {V}_{t - n}^{3} ,$$
respectively;
S5, calculating a reactive power command compensation component
$$Δ {Q}_{t}^{*}$$
of a new energy unit at the current moment t by using the first-order difference component, the second-order difference component, and the third-order difference component of the voltage amplitude at the current moment t, namely
$${V}_{t}^{1} , {V}_{t}^{2} , and {V}_{t}^{3} ,$$
and denoting the reactive power command compensation components at the previous moments as
$${Q}_{t - 1}^{*} , {Q}_{t - 2}^{*} , … , Δ {Q}_{t - n}^{*} ,$$
respectively;
S6, calculating an optimized reactive power command value
$${Q}_{p \_ t}^{*}$$
at different moments by using basic reactive power command values (Qₜ, Qₜ₋₁, . . . , Qₜ₋ₙ) of the new energy unit at different moments, so as to realize lag compensation of a reactive power command; and
S7, adding the optimized reactive power command value
$${{Q}_{p \_ t}}^{*}$$
and the reactive power command compensation component
$$Δ {{Q}_{t}}^{*}$$
to obtain the reactive power command
$${{Q}_{t}}^{*}$$
of the new energy unit, sending the power command to a new energy converter, and completing power command tracking through the new energy converter.

2. The reactive power control method for suppressing a transient overvoltage in a DC sending-end power grid of new energy according to claim 1, wherein in the S1, the equivalent grid voltage amplitudes at different moments are obtained through the following equation (1) so as to play a role in smoothing filtering:
$$\{ \begin{matrix}{V}_{t} = \frac{{U}_{t} + {U}_{t - 1} + {U}_{t - 2} + {U}_{t - 3}}{4} \\ ⋮ ⋮ \\ {V}_{t - n} = \frac{{U}_{t - n} + {U}_{t - n - 1} + {U}_{t - n - 2} + {U}_{t - n - 3}}{4}\end{matrix} . \qquad ( 1 )$$

3. The reactive power control method for suppressing a transient overvoltage in a DC sending-end power grid of new energy according to claim 1, wherein in the S2, the first-order difference components of the voltage amplitude at different moments are obtained through the following equation (2):
$$\{ \begin{matrix}{V}_{1}^{1} = {V}_{t} - {V}_{t - 1} \\ ⋮ ⋮ \\ {V}_{t - n}^{1} = {V}_{t - n} - {V}_{t - n - 1}\end{matrix} . \qquad ( 2 )$$

4. The reactive power control method for suppressing a transient overvoltage in a DC sending-end power grid of new energy according to claim 1, wherein in the S3, the second-order difference components of the voltage amplitude at different moments are obtained through the following equation (3):
$$\{ \begin{matrix}{V}_{t}^{2} = {V}_{t}^{1} - {V}_{t - 1}^{1} \\ ⋮ ⋮ \\ {V}_{t - n}^{2} = {V}_{t - n}^{1} - {V}_{t - n - 1}^{1}\end{matrix} . \qquad ( 3 )$$

5. The reactive power control method for suppressing a transient overvoltage in a DC sending-end power grid of new energy according to claim 1, wherein in the S4, the third-order difference components of the voltage amplitude at different moments are obtained through the following equation (4):
$$\{ \begin{matrix}{V}_{t}^{3} = {V}_{t}^{3} - {V}_{t - 1}^{3} \\ ⋮ ⋮ \\ {V}_{t - n}^{3} = {V}_{t - n}^{3} - {V}_{t - n - 1}^{3}\end{matrix} . \qquad ( 4 )$$

6. The reactive power control method for suppressing a transient overvoltage in a DC sending-end power grid of new energy according to claim 1, wherein in the S5, the reactive power command compensation component at different moments is obtained through the following equation (5), in the equation, kᵥ represents a reactive power compensation coefficient, which is designed as 1.5 as recommended by grid connection guidelines, or also adjusted and increased according to actual reactive power output capacity of the new energy unit:
$$\{ \begin{matrix}Δ {{Q}_{t}}^{*} = {k}_{v} ( {V}_{t}^{1} + {V}_{t}^{2} + {V}_{t}^{3} ) {I}_{N} \\ ⋮ ⋮ \\ Δ {{Q}_{t - n}}^{*} = {k}_{v} ( {V}_{t - n}^{1} + {V}_{t - n}^{2} + {V}_{t - n}^{3} ) {I}_{N}\end{matrix} . \qquad ( 5 )$$

7. The reactive power control method for suppressing a transient overvoltage in a DC sending-end power grid of new energy according to claim 1, wherein in the S6, the optimized reactive power command value
$${{Q}_{p \_ t}}^{*}$$
at different moments t is obtained through lead-lag compensation calculation of the basic reactive power command values Qₜ at different moments, specifically through the equation (6), in the equation,
$${{Q}_{p \_ 1}}^{*} and {{Q}_{p \_ 0}}^{*}$$
respectively represent the optimized basic reactive power command values at an initial moment and a first moment of an algorithm, and Q₁ and Q₀ respectively represent the reactive power command values at the initial moment and the first moment of the algorithm:
$$\{ \begin{matrix}{{Q}_{p \_ t}}^{*} = {{Q}_{p \_ t - 1}}^{*} - 1.49 {{Q}_{p \_ t - 1}}^{*} + {Q}_{t} - 1.49 {Q}_{t - 1} + 0.52 {Q}_{t - 2} \\ ⋮ ⋮ \\ {{Q}_{p \_ 1}}^{*} = {Q}_{1} \\ {{Q}_{p \_ 0}}^{*} = {Q}_{0}\end{matrix} . \qquad ( 6 )$$

8. The reactive power control method for suppressing a transient overvoltage in a DC sending-end power grid of new energy according to claim 1, wherein in the S7, the reactive power command
$${{Q}_{t}}^{*}$$
of the new energy unit at different moments t is obtained by adding the optimized reactive power command value
$${{Q}_{p \_ t}}^{*}$$
and the reactive power command compensation component
$$Δ {{Q}_{t}}^{*} ,$$
and the calculation process is completed through the following equation (7):
$${{Q}_{t}}^{*} = {{Q}_{p \_ t}}^{*} + Δ {{Q}_{t}}^{*} . \qquad ( 7 )$$
